(19) United States
(12) Patent Application Publication
(10) Pub. No.: US 2019/0376282 A1
(43) Pub. Date: Dec. 12, 2019

(54) MODULAR ARCHITECTURAL WALL SYSTEM

(71) Applicant: Top Life Contract Glazing, Inc., Osceola, WI (US)

(72) Inventors: Timothy J. Michel, Lindstrom, MN (US); Eric Goodman, Osceola, WI (US)

(21) Appl. No.: 16/386,596

(22) Filed: Apr. 17, 2019

Related U.S. Application Data
(60) Provisional application No. 62/659,847, filed on Apr. 19, 2018.

(51) Int. Cl. E04B 2/72; E04C 2/54; E06B 3/36; E06B 3/42; H01R 13/73

(52) U.S. Cl. CPC E04B 2/723; E04B 2/721; H01R 13/73; E06B 3/36; E06B 3/42; E04C 2/54

(57) ABSTRACT

A modular, lightweight, nonload bearing, space dividing architectural wall system. The architectural wall system configured to be installed in an opening defined by one or more studs of an interior wall and to interlock with one or more at least partially surrounding panels of sheet rock adhered to the one or more studs. The architectural wall system including one or more modular panels, each modular panel including at least a three sided extruded metal perimeter frame having a cross-section including a rectangular tubular portion and a pair of opposed sheet rock accommodating brackets, each defining a channel configured to receive an edge of the one or more at least partially surrounding panels of sheet rock, thereby interlocking the perimeter frame with the at least partially surrounding panels of sheet rock to secure the perimeter frame to the interior wall and to provide a finished appearance to the opening.

### RELATED APPLICATION INFORMATION

This application claims the benefit of U.S. Provisional Application No. 62/659,847, filed Apr. 19, 2018, the contents of which are fully incorporated herein by reference.

### TECHNICAL FIELD

The present invention relates to modular architectural wall systems, and more particularly to a modular, lightweight, non-load bearing architectural wall system configured to interlock with one or more at least partially surrounding panels of sheet rock.

### BACKGROUND

Increasingly, interior spaces have become commodities that demand flexibility and affordability of design without compromising function, quality, or style of interior construction. These interior spaces are commonly commercial spaces such as retail stores, pop-up shops, communal work shares, and traditional office spaces. Spaces such as these often include large open areas that can be divided into smaller spaces such as offices, workstations, collaboration rooms, meeting spaces, break-room type spaces, etc. These spaces are typically divided with space divider and panel systems that can be arranged in formations according to the need of the space.

Typical space divider systems usually employ upright structures such as panels, arranged and connected in a serial fashion. These panels typically have a variety of widths and heights. For example, some panels can be constructed in a fashion that span heights from floor to ceiling, creating completely enclosed areas, while others can have heights that span a few feet, creating semi-enclosed spaces. Panels and systems used for dividing and creating spaces also typically cooperate with additional office components. These components can include file cabinets, shelving units, and/or desks, all of which may be optionally mounted to the wall panel itself.

Panels and systems for creating or dividing spaces are almost exclusively used in “finished” spaces, such as spaces where permanent walls and associated structures have been constructed. Construction of permanent or “hard” walls and structures often requires ample time, noise, and increasing costs as well as a dramatically decreased flexibility and feasibility in configuration of new spaces or alteration of pre-existing structures. As such, these panel and space dividing and creating systems are usually preferred to traditional dry-wall and stud construction. Known wall panel systems achieve substantially the same result of dividing and creating unique spaces, while also providing increased efficiency in construction and flexibility and decreased costs. Some examples of these known panels and systems have been disclosed in U.S. Pat. No. 4,682,457 to Spencer (“Spencer”), U.S. Pat. No. 4,798,035 to Mitchell et al. (“Mitchell”), U.S. Pat. No. 5,809,708 to Greer et al. (“Greer”), and U.S. Pat. No. 9,249,567 to Yu et al (“Yu”).

Panels and systems described thus far are typically the preferred embodiment used in modifying large, open spaces. In dividing open office areas into smaller work or collaboration spaces, each panel and arrangement typically has a variety of constructions. For example, Yu discloses wall panels constructed of support rails and facing sheets made from conventional construction materials, where the wall panels can be readily cut to length in the field by an installer. Likewise, Mitchell also discusses wall panels readily available for installation in “finished” spaces that can be modified and cut at installation site by an installer. Spencer and Greer also disclose panels that are compatible with “finished” spaces.

Regardless of the panel structure or system used to create and define interior spaces, the panels and/or system must be easily installed and adaptable to new or changing floor plans while also providing for additional utilities such as light, sound, and electrical connections. For those modular systems that provide an electrical system, the electrical pathways are provided through one of two methods. Some modular panels are true “plug-in” designs, with the individual panels pre-wired and connected to one another through electrical connectors formed as part of the panel. Such systems are shown in U.S. Pat. No. 4,270,020 to Kenworthy, et al.; U.S. Pat. No. 4,231,630 to Propst, et al; and U.S. Pat. No. 4,239,932 to Textoris, et al.

The alternative to the “plug-in” modular systems, one that provides a greater degree of flexibility, makes use of raceways formed within the modular partitions to carry the necessary electrical and communications wires. After formation of the partitions, the wiring is placed in the appropriate raceways to create the power grid required by the plan. An example of such a raceway system is shown in Codrea, U.S. Pat. No. 3,195,698, previously cited herein. The raceway passages permit the wiring to be placed where needed for a particular application, whereas the “plug-in” system avoids the necessity for wiring the partition subsequent to assembly. A combination of both systems is taught by Haworth, et al., in U.S. Pat. No. 4,060,294.

Panels and modular systems must also be readily adaptable to the design and layout of an existing building structure. One major problem encountered by pre-fabricated structures is the orthogonality or symmetry of existing walls, floors, and ceilings, in even the most well constructed buildings. Floors and ceilings are often not parallel with one-another, especially in high-rise buildings and older constructed buildings where modular systems and prefabricated structures are frequently sought after. Unevenness and unlevelness of these surfaces introduces the additional challenge of conforming prefabricated or pre-cut panels to these variable structures.

In addition to problems caused by uneven floors, ceilings and walls, a still further design problem is created where these panels and/or modular systems incorporate glass panels or other fracturable material. Glass panels for use in panels and/or modular systems are known. The glass panels in such panels are generally made up of two spaced panes, for example of hardened glass. Usually, such glass panes are heavy, which makes mounting and removing the panes (for example in the case of a broken pane) a laborious, time consuming, and expensive task. Additionally, glass panels known in the art need to be firmly anchored therein for safety reasons. An improvement to panels with glass is disclosed in U.S. Pat. No. 9,506,246 to Joseph et al. (“Joseph”). Joseph discloses easy to remove glass panels with glass “mounted” to the panel in a firmly attached manner. Panels disclosed in Joseph are not fully integrated into the panel itself, and require additional installation.

Modular systems are often designed to work as a cohesive unit, which can make removable glass an attractive option, but yet still an option that requires expertise in removal and installation. Even still, separate glass inserts and varying connectors between panels requires that each of the separate pieces be connected uniformly. Consequentially these systems are generally unable to adapt to variations commonly presented in existing commercial spaces. Most systems utilize a metal clipping arrangement, whether the U-shaped connectors of, for example, Halsey, et al., U.S. Pat. No. 3,282,006, or the more complex connecting plates of Gartung, U.S. Pat. No. 4,185,430. All of these metal plate connectors rely on the clamping force of the clip to keep the separate units together, and rely on friction to keep the metal plate connectors in place. Added security can be obtained by utilizing both metal connecting plates and bolts, such as in Timmons, U.S. Pat. No. 4,269,005. Connectors often inhibit movement of connected panels to inhibit unintentional movement of an installed modular configuration.

Regardless of the type of connector used, panels and modular systems are typically connected in a way that enables at least a small degree of flexibility; thereby enabling movement for existing or new changes in interior space structures. The market for these types of open spaces is highly competitive and increasingly demanded. Therefore, new panel and modular system designs are constantly being introduced into the marketplace, which drives innovation and improvements to existing panel designs and modular system structures.

Though many types of prefabricated panels and modular systems are known, there remains a need for prefabricated panels and/or modular systems that can be incorporated into a space during the construction phase, before a space is considered finished. Moreover, there is a need for modular, architectural wall systems that integrate with permanent or hard walls of traditional drywall and stud construction, in a manner that reduces the overall amount of time and cost associated with finishing a space. This need is especially apparent with glass panels that typically require post installation glazing and fabrication from professionals in the field.

The present disclosure addresses these concerns.

### SUMMARY OF THE DISCLOSURE

Embodiments of the present disclosure provide a modular, lightweight, non-load bearing, space dividing architectural wall systems configured to interlock with the drywall and studs of a typical permanent or hard wall construction. In particular, embodiments of the present disclosure provide architectural wall systems that are configured to be installed in an opening defined by an interior wall in a manner in which edges of panels of sheet rock are received within portions of the architectural wall systems, thereby interlocking the architectural wall systems with the sheet rock and studs to both secure the architectural wall system to the interior wall and to provide a finished appearance to the opening. As a result, architectural wall systems of the present disclosure enable the finishing of interior walls in a manner that reduces the overall amount of time and cost; particularly, as edges of the drywall are covered by the architectural wall systems, thereby significantly reducing the need to mud and tape the drywall surrounding the modular, architectural wall systems.

It should be appreciated that the term “stud” refers to any upright or vertical support in a wall of a building to which sheathing, drywall, etc. is attached. Wall studs can be either metal or wood and can include a variety of dimensions, many of which are considered standard size dimensions in the construction industry. The term “drywall” refers to any type of board or sheathing, such as those made from plasterboard, wallboard, gyprock, gypsum board and/or gypsum panel, for the construction of interior walls. Various descriptions are made herein, for the sake of convenience, with respect to integration of the architectural wall systems with studs and drywall, while the disclosure is not limited in this respect.

One embodiment of the present disclosure provides a modular, lightweight, non-load bearing, space dividing architectural wall system configured to be installed in an opening defined by one or more studs of an interior wall and to interlock with one or more at least partially surrounding panels of sheet rock adhered to the one or more studs. The architectural wall system can include one or more modular panels, each modular panel including at least a three sided extruded metal perimeter frame having a cross section including a rectangular tubular portion and a pair of opposed sheet rock accommodating brackets. The rectangular tubular portion can be configured to be secured to one or more studs of an interior wall, and can have a width sized to match the width of the one or more studs. The pair of opposed sheet rock accommodating brackets can extend beyond the width of the rectangular tubular portion. Each of the pair of opposed sheet rock accommodating brackets can define a channel configured to receive an edge of the one or more at least partially surrounding panels of sheet rock, thereby interlocking the perimeter frame with the at least partially surrounding panels of sheet rock to further secure the perimeter frame to the interior wall to provide a finished appearance to the opening.

In one embodiment, the opposed sheet rock accommodating brackets can be configured to receive a panel of sheet rock having a standard thickness. Standard thicknesses for sheet rock includes thicknesses of approximately ½ of an inch and/or approximately ⅜ of an inch; although the receipt of other sheet rock thicknesses within the sheet rock accommodating brackets is also contemplated. In one embodiment, the width of the rectangular tubing portion can be sized to the width of a standard sized stud. Standard widths for studs include widths of approximately 1⅜ inches, 1⅝ inches, 2 inches, 2½ inches, and/or 3 inches; other stud widths are also contemplated. In one embodiment, a depth of the pair of opposed sheet rock accommodating brackets is the same as a depth of the rectangular tubular portion, thereby enabling two or more modular panels to be secured together with a finished appearance, wherein the sheet rock accommodating brackets are flush with one another, thereby inhibiting the presence of a significant gap between the two or more modular panels.

In one embodiment, the architectural wall system can further include one or more shims configured to be positioned between the perimeter frame and the one or more studs prior to securing the rectangular tubular portion to the one or more studs of the interior wall, thereby enabling the architectural wall system to account for a lack of orthogonality and/or symmetry of the walls, floors, and ceilings of the interior space.

In one embodiment, the perimeter frame can house a rigid panel. In one embodiment, the rigid panel can include at least one of a transparent and/or translucent portion, such as a window or frosted glass or plastic pane. In one embodiment, the rigid panel can include at least one of a hinged and/or sliding window configured to transition between an open and closed configuration. In one embodiment, the rigid panel can include at least one of an electrical outlet and/or other electrical coupling, such as a USB jack, telephone jack, cable output, network connection, and/or other jack or output configured to transmit and receive an electrical signal. In one embodiment, the perimeter frame can include a pivotable door, thereby enabling passage through the completed interior wall.

Another embodiment of the present disclosure provides a method of constructing a modular, lightweight, non-load bearing space dividing architectural wall system in an opening defined by one or more studs of an interior wall. The method can comprise the steps of: partially building an interior wall with one or more studs, wherein the one or more studs define an opening; securing one or more modular panels within the opening defined by the one or more studs, each modular panel including at least a three sided extruded metal perimeter frame having a cross section including a rectangular tubular portion configured to be secured to the one or more studs and having a width sized to match the width of the one or more studs, and a pair of opposed sheet rock accommodating brackets extending beyond the width of the rectangular tubular portion, the pair of opposed sheet rock accommodating brackets each defining a channel; and adhering one or more panels of sheet rock to the one or more studs of the interior wall, such that the one or more modular panels are at least partially surround by the one or more panels of sheet rock, wherein an edge of at least one of the one or more partially surrounding panels of sheet rock is received within the channel defined by the sheet rock accommodating brackets, thereby interlocking the perimeter of the frame with the at least partially surrounding panels of sheet rock to further secure the perimeter frame to the interior wall and to provide a finished appearance to the opening.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable.

In one embodiment, the present invention relates to pre-fabricated internal office structures for use in creating and defining spaces within larger interior spaces. The pre-fabricated internal office structures comprise a panel or multiple panels with an upper portion that can be optionally be fixed to a ceiling and a lower portion to be fixed to a floor. In an alternative embodiment, the lower portion is fixed to the floor and the upper portion of a panel is not connected to the ceiling. In yet an even other embodiment, the upper portion is fixed to the ceiling and the lower portion is not fixed to the floor.

In some embodiments panels may be constructed from a singular piece of extruded material. In other embodiments the panels may be constructed from multiple pieces of extruded materials. In embodiments these materials may be steel or other metals alloys, plastic, synthetic or semi-synthetic organic compounds that are malleable and moldable into a solid object, or any other type of material suitable for creating a solid or semi-solid panel structure.

Embodiments also relate to panels that may optionally include embedded or removable sections of material that is discontinuous from the main frame of the panel. Such sections could include glass inserts that may be embedded or optionally removable from a panel. Other materials used in these sections could include glass, plastic, wood, or any other material suitable for panel for creating a solid or semi-solid panel structure. In yet another embodiment, a panel may include a door.

Embodiments relate to panels that provide a continual connection from floor to ceiling. In other embodiments, panels may be of a size that is equivalent to half the height of a room's height. In yet even other embodiments, the panels may be of such a size that it can be connected to an upper or lower portion of a panel to create a dividing section that is more than one continual panel portions. In yet even other embodiments, a panel may be a size custom created for a space.

In dividing spaces, individual panels may have a variety of constructions. In one embodiment a panel may be installed directly to a wall and stud during building construction. In an alternative embodiment a panel may be connected to an existing wall structure or “retrofitted” to an existing space. Regardless of whether a panel is installed directly to a stud or retrofitted to an existing structure, the panel or plurality of panels are serially connected to each other at one or more connector sites. With such an arrangement one or more panels may be connected in serial fashion to divide or create a space. Alternatively, a panel or plurality of panels may be connected to form a “T-section” wherein three panels meet and are joined at a common junction by one or more connector sites. Panels may also be connected to form a “cross section” wherein four panels meet and are joined at a common junction by one or more connector sites.

In one non-limiting example, a panel with an embedded or removable glass may be serially connected with a solid or semi-solid panel to create a wall or room with a window. In another non-limiting example, panels with embedded frosted glass may be serially connected to create a space divider that allows for natural light to pass through, while also creating a semi-private divider. In yet another non-limiting embodiment, a smaller panel with embedded glass may be fixed to a ceiling at its upper portion and simultaneously connected at its lower portion to a panel comprising a door.

In some embodiments, provisions for mounting various office furniture components such as a desk, shelving, overhead storage, cabinets, and any other components that may be suitable for office use. The panels may also be configured to allow electric cables or other cords throughout. Optionally panels may include one or more outlets configured for typical electrical plugs, foreign outlet plugs, USB connections, or any other connection that may be suitable for providing power to a user.

Embodiments of panels described herein are readily reconfigurable to space-dividing prefabricated structures which can be optionally combined with a connector to create a system that can divide or create internal spaces.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of an embodiment for use with studs and drywall according to the present disclosure.

FIG. 2 is a perspective view of an embodiment for use with studs and drywall according to the present disclosure.

FIG. 3 is a perspective view of an embodiment for use with studs and drywall according to the present disclosure.

FIG. 4 is a perspective view of an embodiment for use with studs and drywall according to the present disclosure.

FIG. 5 is a perspective view of an embodiment according to the present disclosure.

FIG. 6 is a perspective view of an embodiment according to the present disclosure.

FIG. 7 is a perspective view of an embodiment according to the present disclosure.

FIG. 8 is a perspective view of an embodiment according to the present disclosure.

FIG. 9 is a perspective view of an embodiment according to the present disclosure.

FIG. 10 is a perspective view of an embodiment according to the present disclosure.

FIG. 11 is a perspective view of an embodiment according to the present disclosure.

FIG. 12 is a perspective view of an embodiment according to the present disclosure.

FIG. 13 is a perspective view of an embodiment according to the present disclosure.

FIG. 14 is a perspective view of an embodiment according to the present disclosure.

FIG. 15 is a perspective view of an embodiment according to the present disclosure.

FIG. 16 is a perspective view of an embodiment according to the present disclosure.

FIG. 17 is a perspective view of an embodiment according to the present disclosure.

FIG. 18 is a perspective view of an embodiment according to the present disclosure.

FIG. 19 is a cross-sectional view of a connector site according to an embodiment of the present disclosure.

FIG. 20 is a cross-sectional view of a connector site according to an embodiment of the present disclosure.

FIG. 21 is a cross-sectional view of a connector site according to an embodiment of the present disclosure.

FIG. 22 is a cross-sectional view of a connector site according to an embodiment of the present disclosure.

FIG. 23 is a cross-sectional view of a connector site according to an embodiment of the present disclosure.

FIG. 24 is a cross-sectional view of a connector site according to an embodiment of the present disclosure.

FIG. 25 is a cross-sectional view of a connector site according to an embodiment of the present disclosure.

FIG. 26 is a cross-sectional view of a connector site according to an embodiment of the present disclosure.

FIG. 27 is a cross-sectional view of a connector site according to an embodiment of the present disclosure.

FIG. 28 is a cross-sectional view of a connector site according to an embodiment of the present disclosure.

FIG. 29 is a cross-sectional view of a connector site according to an embodiment of the present disclosure.

FIG. 30 is a cross-sectional view of a connector site according to an embodiment of the present disclosure.

FIG. 31 is a cross-sectional view of a connector site according to an embodiment of the present disclosure.

FIG. 32 is a cross-sectional view of a connector site according to an embodiment of the present disclosure.

FIG. 33 is a cross-sectional view of a connector site according to an embodiment of the present disclosure.

FIG. 34 is a cross-sectional view of a connector site according to an embodiment of the present disclosure.

FIG. 35 is a cross-sectional view of a connector site according to an embodiment of the present disclosure.

FIG. 36 is a cross-sectional view of a connector site according to an embodiment of the present disclosure.

FIG. 37 is a cross-sectional view of a connector site according to an embodiment of the present disclosure.

FIG. 38 is a cross-sectional view of a connector site according to an embodiment of the present disclosure.

FIG. 39 is a cross-sectional view of a connector site according to an embodiment of the present disclosure.

FIG. 40 is a cross-sectional view of a connector site according to an embodiment of the present disclosure.

FIG. 41 is a cross-sectional view of a connector site according to an embodiment of the present disclosure.

FIG. 42 is a cross-sectional view of a connector site according to an embodiment of the present disclosure.

FIG. 43 is a cross-sectional view of a connector site according to an embodiment of the present disclosure.

FIG. 44 is a cross-sectional view of a connector site according to an embodiment of the present disclosure.

FIG. 45 is a cross-sectional view of a connector site according to an embodiment of the present disclosure.

FIG. 46 is a cross-sectional view of a connector site according to an embodiment of the present disclosure.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

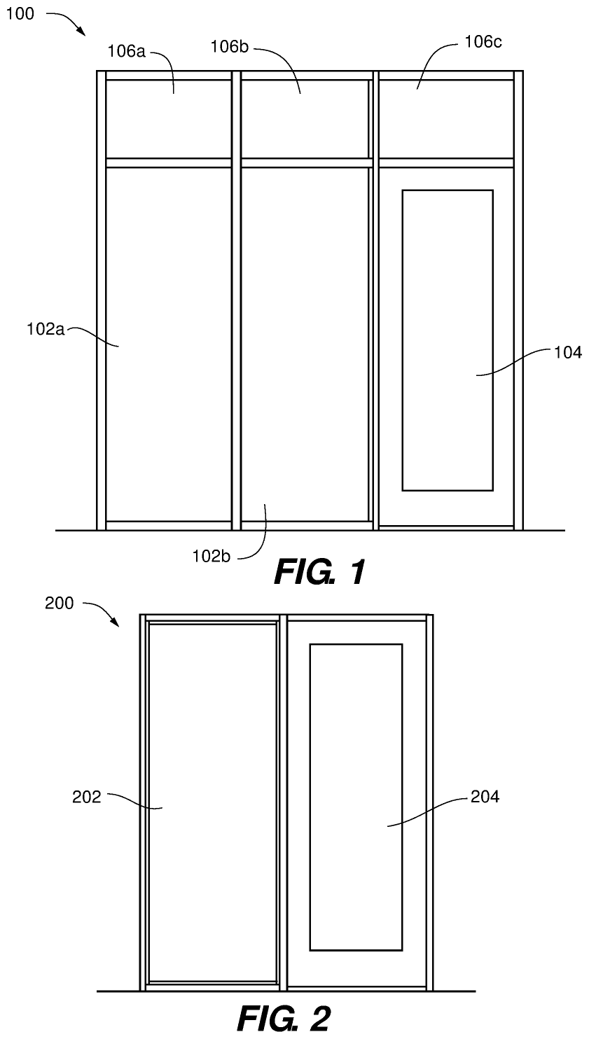

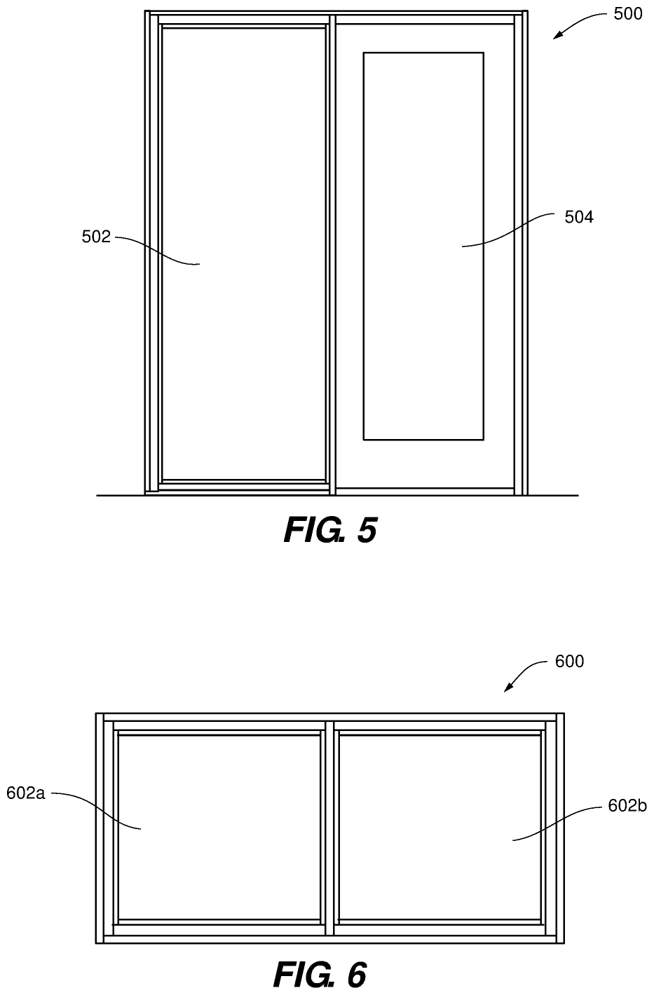

As illustrated in FIGS. 1-4, one embodiment of the invention generally relates to a pre-fabricated office system defined by one or more pre-fabricated structures to be used during a construction phase of an internal space. As illustrated in FIGS. 5 and 6, according to an alternative embodiment, the invention is generally related to a modular pre-fabricated office system defined by one or more pre-fabricated structures to be used in conjunction with the structure of an existing internal space.

According to embodiments, a pre-fabricated office structure comprises a singular solid or semi-solid panel defined by a perimeter frame and one or more connector sites. The structures can include an upper portion and a lower portion. In one embodiment structures used herein may be comprised of a semi-solid or solid panel comprised of a solid or semi-solid panel made of steel, aluminum, or other metal alloy, wood, plastic, synthetic or semi-synthetic organic compounds or any other material that is suitable for creating a solid or semi-solid panel. In an alternative embodiment a structure may be comprised of a panel with embedded glass, plastic, or other material that allows for light or brightness to pass through. Though some suitable materials for panels have been disclosed herein, it is understandable that any material suitable for a pre-fabricated office structure or a material known to one skilled in the art may be used.

As illustrated in FIG. 1 a pre-fabricated office system may comprise a plurality of structures 102a, b, 104, and 106a, b, c, connected at a connector site (not shown) and readily positioned and sized to define a variety of configurations to create, define, or divide an internal space. These newly created spaces can have a variety of sizes and configurations to define individual workspaces, meeting rooms, board rooms, or any other type of space that would suit the individual needs of the space. According to embodiments the structures can be used to create open-concept type spaces, partially enclosed spaces, or completely enclosed spaces. In embodiments the structures can be arranged in a straight fashion. According to an alternative embodiment the structures can be arranged in a curved fashion. In an alternative embodiment, the structures can be arranged in any such way that would conform to the needs of the space.

In one non-limiting example of an embodiment, the structures can be arranged in such a way as so “off-set” any orthogonal or symmetry discrepancies created by existing walls, floors, and ceilings. Pre-fabricated structures and office systems are also amenable to wiring, cables, outlets and any other utility demanded by a space. As described herein, pre-fabricated structures according to embodiments of the invention are readily configurable and modifiable for use with dry wall and/or studs, or with pre-existing structures such as walls or dividers.

FIG. 1 illustrates a pre-fabricated office system 100 according to an embodiment. Pre-fabricated office system 100 comprises one or more structures 102a, b, 104, and 106a, b, c, that can be arranged in such a way so as to create, define, or divide a space. Structures according to an embodiment of the invention are comprised a framing material embedded with a panel material and are connected to each other via one or more connector sites. According to an embodiment, a semi-solid or solid structure 102a and 102b can comprise a solid or semi-solid panel made of steel, aluminum, or other metal alloy, wood, plastic, synthetic or semi-synthetic organic compounds or any other material that is suitable for creating a solid or semi-solid panel. According to an embodiment, structure 102a and 102b may also optionally include an embedded or removable section of material such as glass, plastic, or any other material suitable for an office space. According to embodiments, pre-fabricated office structure 100 can also include a door 104. In one embodiment structure 104 is a hinged door. In an alternative embodiment door 104 is a sliding door. In yet even other embodiments, door 104 is any type of door suitable to the needs of the space.

Structures 102a, 102b and 104 are defined by an upper portion that may be optionally connected to a ceiling or an additional panel structure 106a, 106b, or 106c, and a lower portion that may be optionally connected to a floor or an additional panel structure. Structures 102a, b 104, and 106a, b, c may also include one or more connector sites (not pictured) used to connect one or more structures to each other or optionally to a stud and/or drywall.

FIG. 2 illustrates a pre-fabricated office system 200 according to an alternative embodiment of the invention. According to one embodiment, a pre-fabricated office system may comprise semi-solid or solid structure 202 connected to structure 204 with embedded glass.

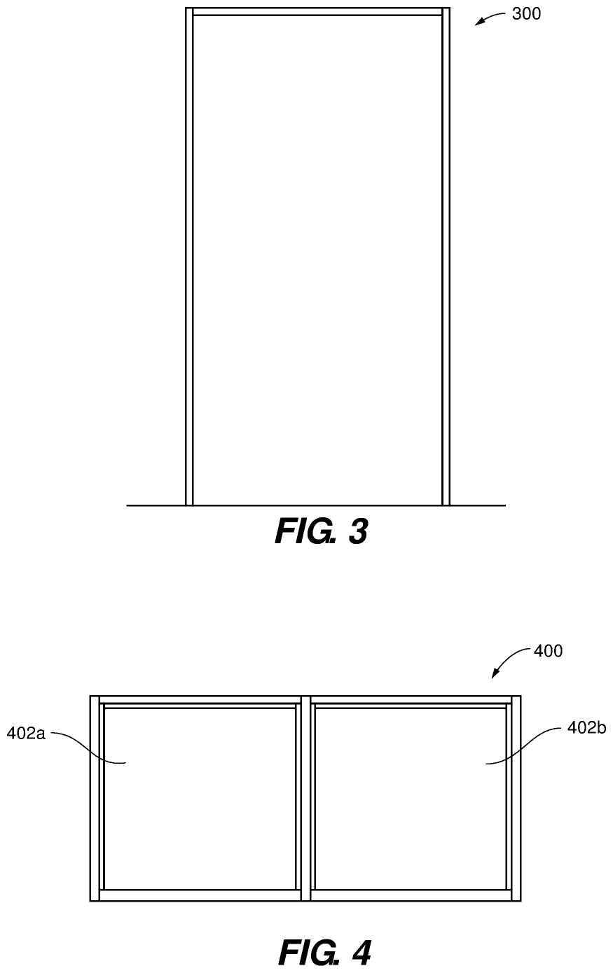

FIG. 3 illustrates a perspective view of an embodiment for use with studs and drywall according to the present disclosure.

Turning now to FIG. 4, FIG. 4 illustrates structures 400 according to an embodiment of the present invention. Structures 404a and 404b have an upper and a lower portion, at least one connector site and may be comprised of any material previously disclosed herein. Alternatively, structures 404a and 404b may have embedded glass. In yet an even different embodiment, structures 404a and 404b may be a window. A window according to this embodiment may be a hinged window or a sliding window. According to embodiments, structure 404a and 404b may be optionally connected at a connector site to one or more structures described herein. In one non-limiting example, the upper portion of structure 404a is fastened to a ceiling and the lower portion of structure 404a is connected to the upper portion of door 300. In an alternative non-limiting example, the lower portion of structure 404a is fastened to the floor and the upper portion is connected to a structure such as 102a or 204.

Though some configurations of pre-fabricated office systems comprised of pre-fabricated structures for use with studs and/or dry wall during a construction phase have been described, it is understandable that the structures of FIGS. 1-4 can be connected in any configuration suitable for a space.

FIGS. 5 and 6 illustrate alternative embodiments of pre-fabricated office system 500 and 600, comprised of individual structures for use with existing building structures. According to one embodiment, pre-fabricated office system 500 comprises a solid or semi-solid structure 502 connected via a plurality of connector sites to a structure embedded with glass. According to an alternative embodiment as illustrated in FIG. 6, a pre-fabricated office system 600 can comprise structures 602a and 602b. Structures 602a and 602b can be comprised of a solid or semi-solid material or alternatively have embedded glass or plastic. According to an embodiment, structures 602a and 602b can be connected to each other at one or more connector sites. According to an alternative embodiment, structures 602a and 602b can be connected to other structures as described herein.

Though many embodiments and possible configurations for pre-fabricated office structure comprised of pre-fabricated structures for use with existing space have been disclosed, it understood that structures comprising a door or a window can also be used. Alternatively structures for use with existing internal spaces can comprise any configuration suitable for office space, including those described for use with studs and/or drywall during a construction phase. In an even other embodiment, structures disclosed in FIGS. 5 and 6 may be configured in arrangements not contemplated by this disclosure, but yet suitable for creating, dividing, and/or defining an interior space.

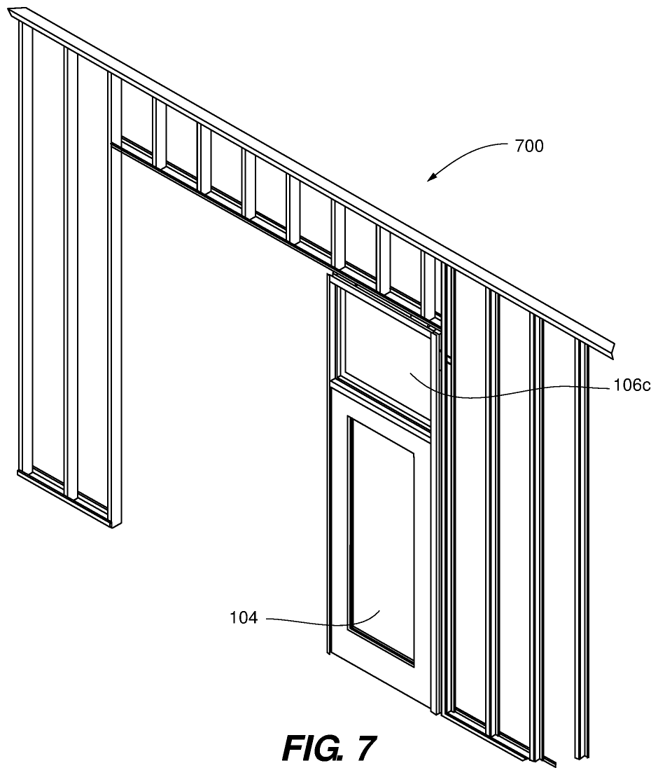

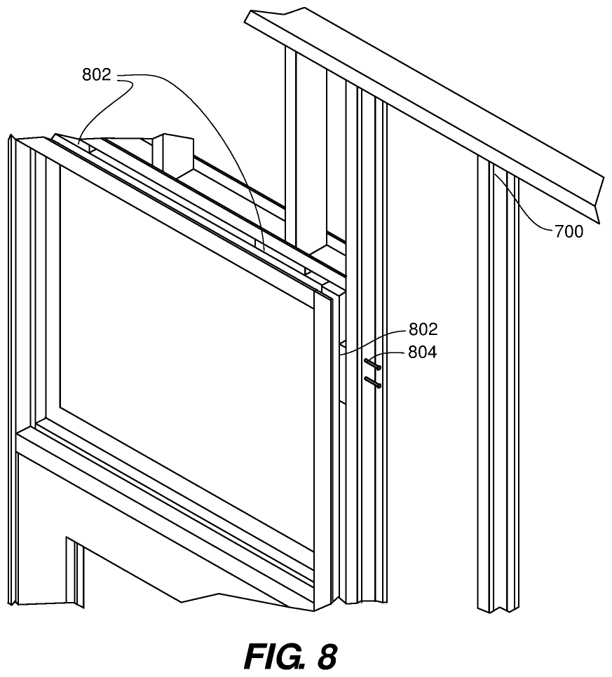

FIGS. 7-18 illustrate structures illustrated in FIG. 1 according to a method of assembly. According to FIG. 7, the upper portion of door with embedded glass 104 connects to the lower portion of embedded glass structure 106c at one or more connecting sites. This unit is brought to the area of installment and situated to stud frame 700. After the unit is installed as depicted in FIG. 8, shims 802 are placed at the one or more connector sites between the stud frame 700 and structures 104 and 106c. Once shims 802 are placed at the one or more connector sites, screws 804 are used to capture, hold, and support structures 104 and 106c.

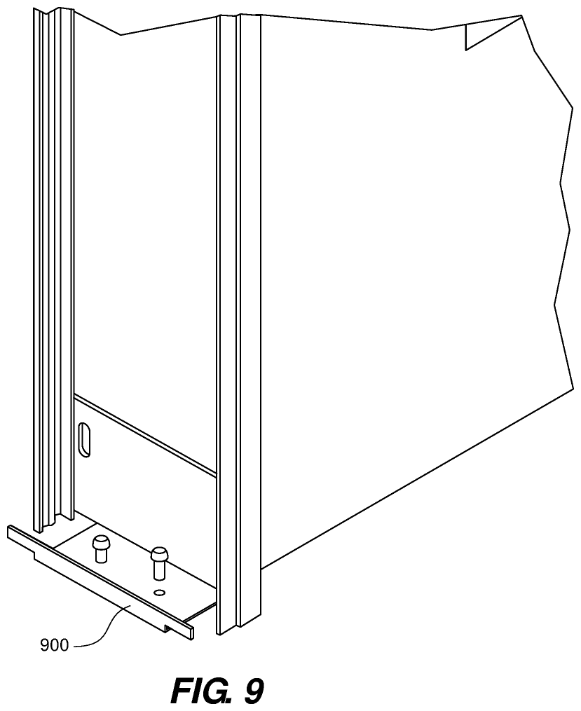

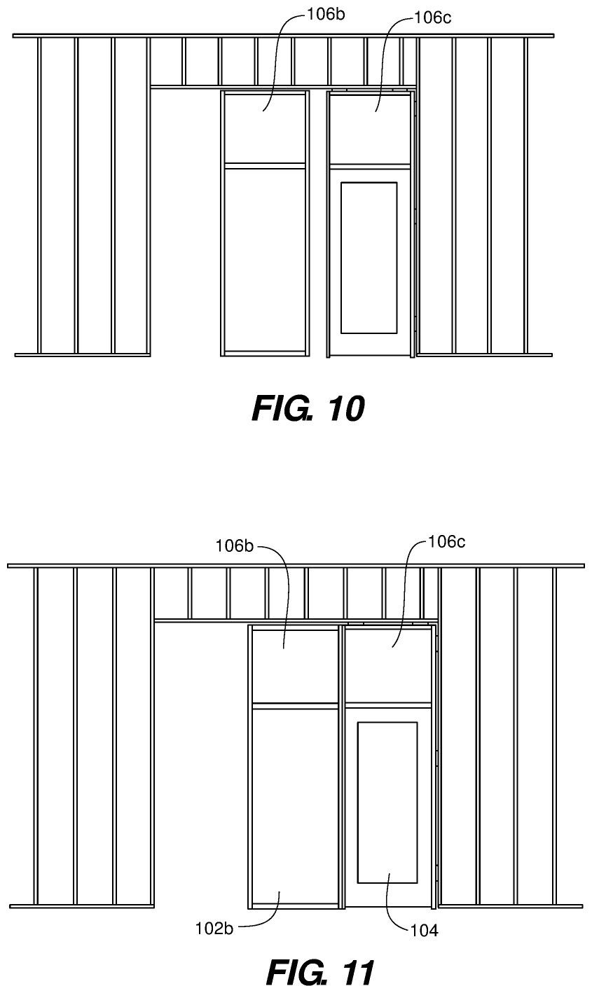

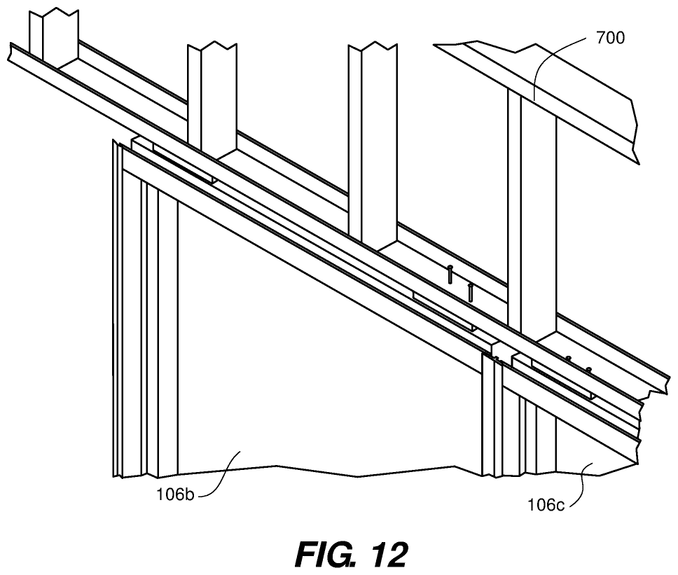

FIG. 9 illustrates base profile 902. Base profile 902 is used to support and secure structure 104 to the ground or floor. After structures 104 and 106c are secured, an additional unit, structure 106b, is attached to structure 102b and positioned in stud frame 700. FIGS. 10 and 11 illustrate the unit as it is positioned in stud frame 700. In FIG. 10 the 106b/102b unit tracks the upper portion of the stud frame until it reaches the previously installed unit. The new unit is positioned until is meets and joins an installed unit. FIG. 11 illustrates that the newly introduced unit nests within splines (not pictured) of the previously installed 106c/104 unit. Once the 106b/102b unit is nested with the installed 106c/104 unit, shims 802 are positioned around the one or more connector sites as illustrated in FIG. 12.

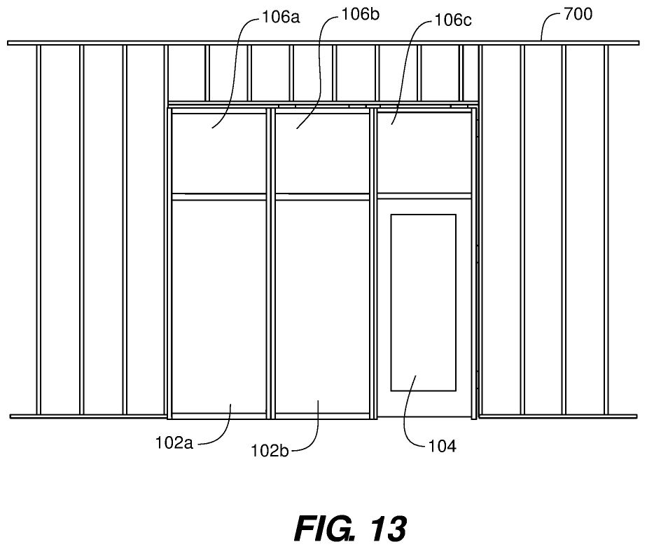

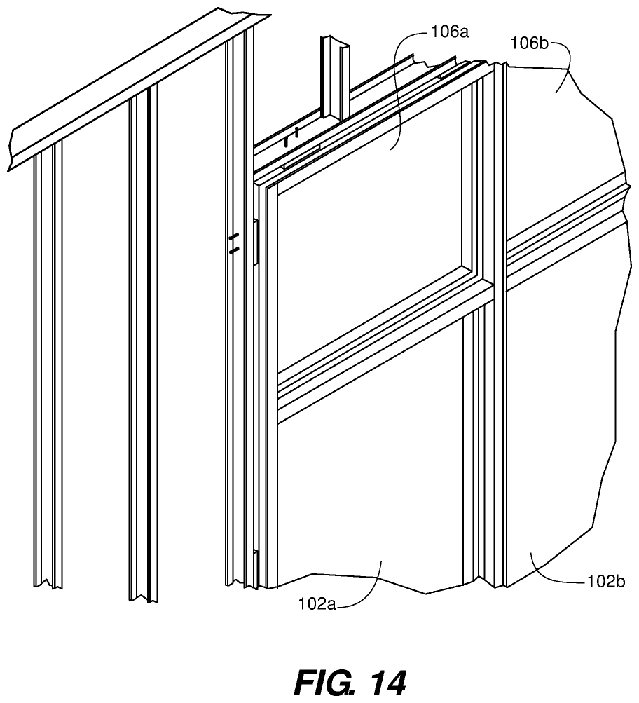

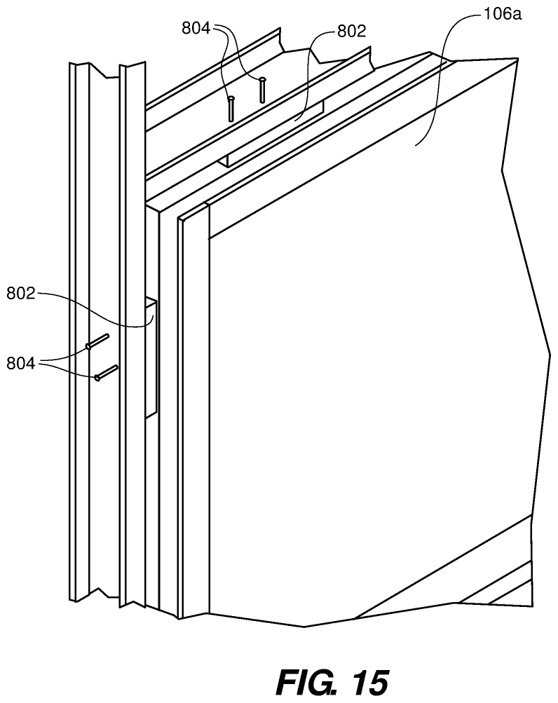

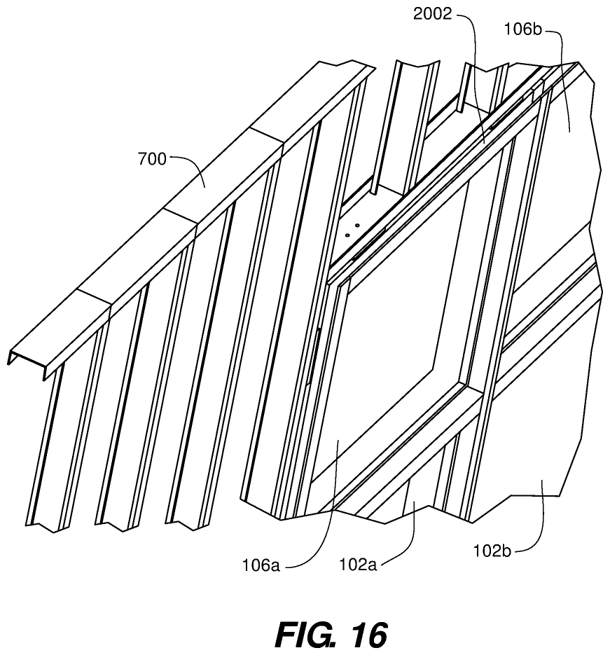

FIG. 13 illustrates the final unit after it is positioned within stud frame. Both FIGS. 14 and 15 illustrate shims 802 being inserted into the one or connector sites of structure 106a and 102a. FIG. 16 illustrates a detailed view pre-fabricated office connector system 100 and splines 1602 used to capture sheetrock during installation. As illustrated in FIGS. 14 and 15, shims 802 are placed at the one or more connector sites and secured with screws 804.

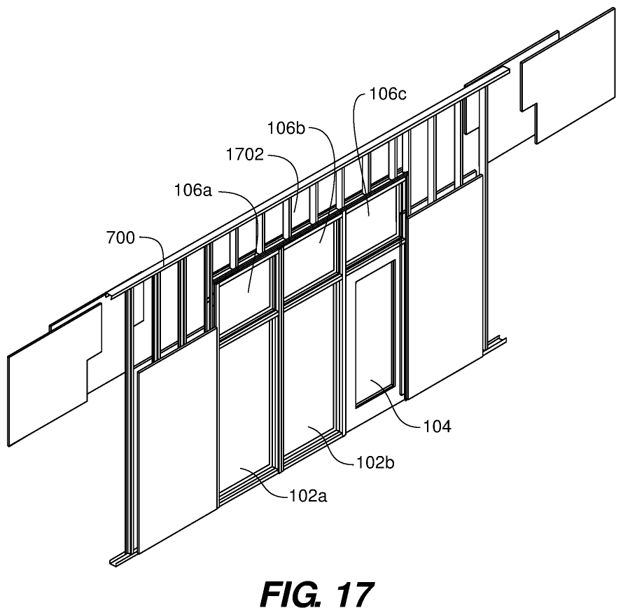

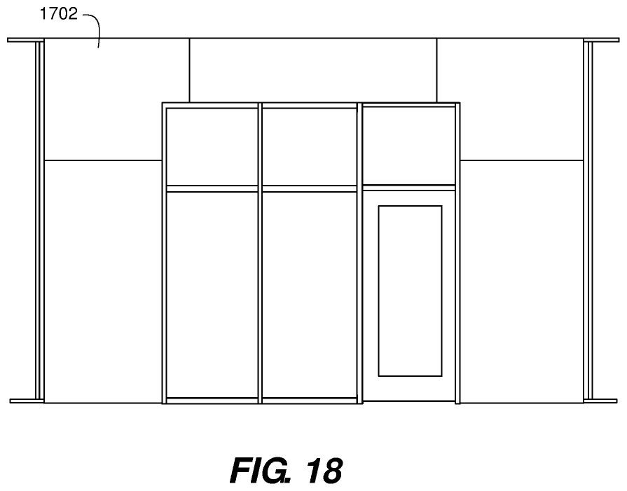

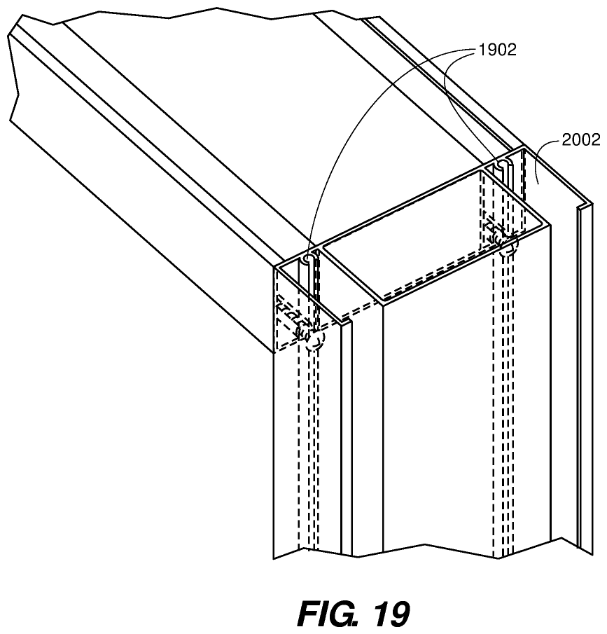

Referring now to FIGS. 16-18, structures disclosed herein can be configured to enable nesting of sheet rock and/or drywall at mullion or first profile site 2002 as illustrated in FIG. 16. FIG. 19 illustrates that mullion 2002 enables capture of the drywall or sheet rock as it is installed around the units. FIG. 17 illustrates the installations of sheet rock and/or drywall as it is installed on frame 700 surrounding previously installed 106a/102a, 106b/102b, and 106c/102c units. As illustrated in FIG. 18, the sheet rock and/or dry wall can be integrated into a seamless structure with pre-existing units, leaving a product ready for finishing. Structures of the pre-fabricated office systems disclosed herein can be continually installed in a serial fashion according to the needs and demands of the internal space.

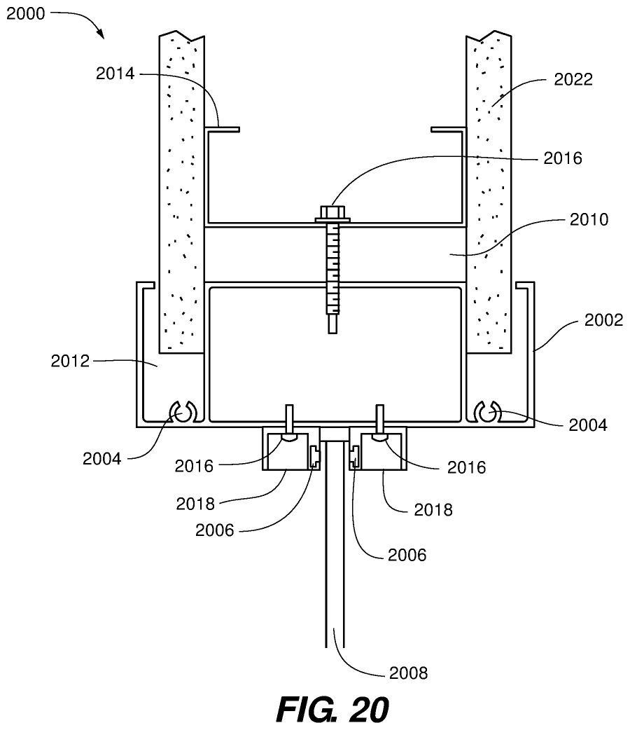

Connector sites, as illustrated in FIGS. 20-46, and as previously described, can be configured to enable a variety of connections. In some embodiments, connectors are configured for use with newly constructed walls, frames and drywall and/or sheet rock. In other embodiments, these connectors are configured for use with preexisting structures such as walls, door frames, or other pre-existing pre-fabricated structures.

FIG. 20 illustrates connector 2000, for use with a stud wall at a location of attachment DD1 as illustrated in FIG. 1. In embodiments, connector 2000 can include first profile 2002, screw spline 2004, rubber gasket 2006, mullion 2012, second profile 2014, screw 2016, and removable cap 2018. In use, second profile 2016 is fixed to the top of shim space 2010 by screw 2016. First profile 2012 is fixed to the bottom of shim space 2010 and is captured by screw 2016. In embodiments, first profile 2012 and second profile 2014 are fixed together by the same screw 2016 to form a unit of attachment for drywall 2022 and glazing 2008. In use, mullion 2012 of first profile 2002 captures drywall 2022. Screws 2016 are secured at the lower portion of first profile 2002 and covered by removable cap 2018. Glazing is fixed to first profile 2002 and rubber gaskets 2006 are placed on either side of glazing 2008 to secure it in place.

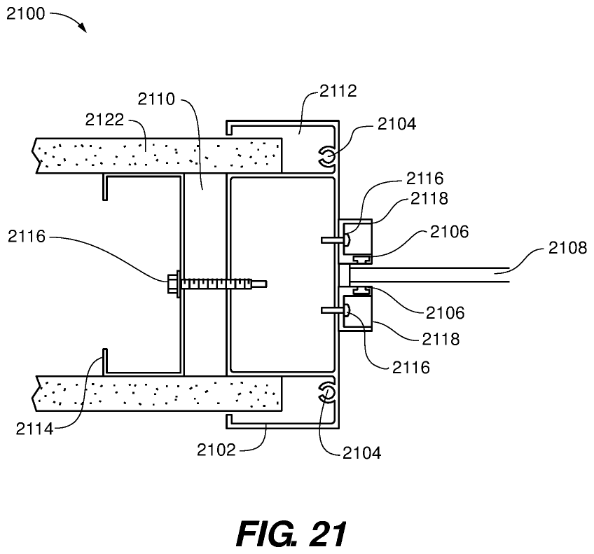

FIG. 21 illustrates connector 2100, for use with a stud wall at a location of attachment DD2 as illustrated in FIG. 1. In embodiments, connector 2100 can include first profile 2102, screw spline 2104, rubber gasket 2106, mullion 2112, second profile 2114, screw 2116, and removable cap 2018. In use, second profile 2016 is fixed to the top of shim space 2110 by screw 2116. First profile 2102 is fixed to the bottom of shim space are fixed together by the same screw 2116 to form a unit of attachment for drywall 2122 and glazing 2108. In use, mullion 2112 of first profile 2102 captures drywall 2122. Screws 2116 are secured at the lower portion of first profile 2102 and covered by removable cap 2118. Glazing is fixed to first profile 2102 and rubber gaskets 2106 are placed on either side of glazing 2108 to secure it in place.

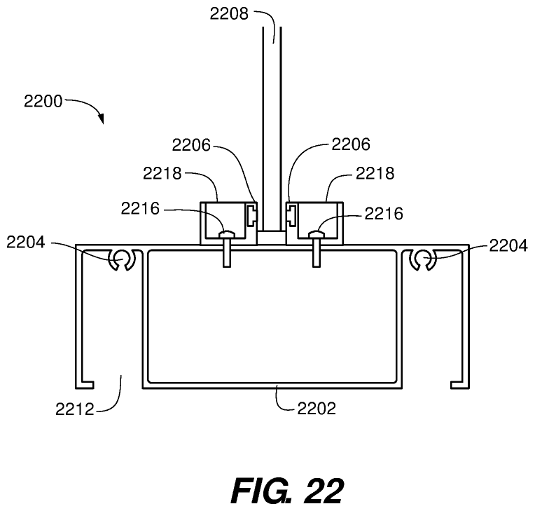

FIG. 22 illustrates connector 2200, for use with a stud wall at a location of attachment DD3 as illustrated in FIG. 1. In embodiments, connector 2200 can include first profile 2202, screw splines 2204, rubber gaskets 2206, mullion 2012, screw 2216, and removable cap 2218. In use, first profile 2202 is fixed to a floor to create a base for glazing 2208. Glazing 2208 is captured by the first profile 2202 and rubber gaskets 2206 are placed in either side to fix glazing into place. In some embodiments, removable caps 2218 can be removed to access screws 2216.

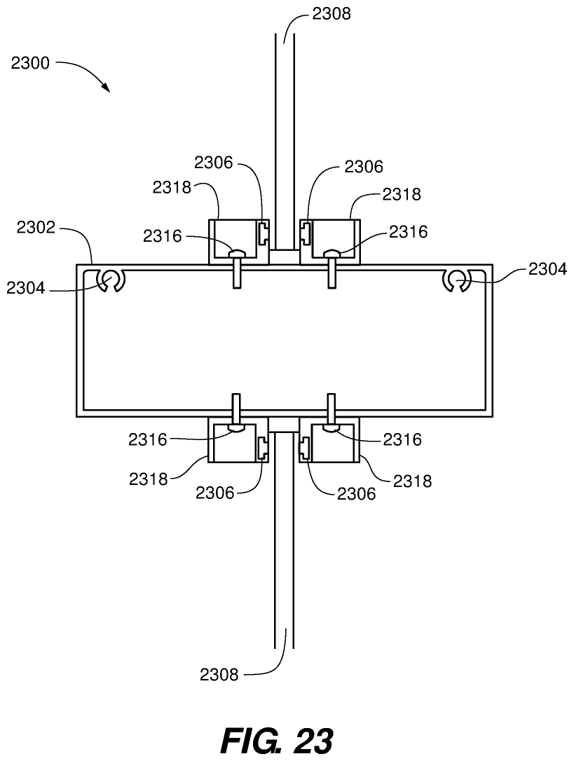

FIG. 23 illustrates connector 2300, for use with a stud wall at a location of attachment DD4 as illustrated in FIG. 1. In embodiments, connector 2300 can include a first profile 2302, screw spline 2304, rubber gasket 2306, screw 2316, and removable cap 2318. In one non limiting embodiment, connector 2300 fixes panels 102a and 102b. Glazing 2308 of panels 102a and 102b is fixed to connector 2300 and secured by rubber gasket 2306. In some embodiments, removable caps 2318 can be removed to access screws 2316.

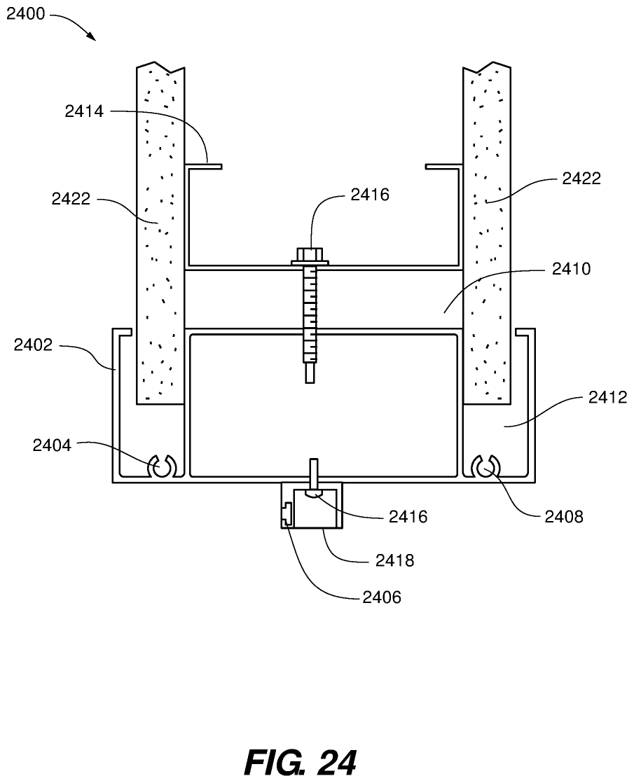

FIG. 24 illustrates connector 2400, for use with a stud wall at a location of attachment DD6 as illustrated in FIG. 2. In embodiments, connector 2400 can include first profile 2402, screw spline 2404, rubber gasket 2406, mullion 2412, second profile 2414, screw 2416, and removable cap 2418. In use, second profile 2416 is fixed to a shim space by screw 2416. First profile 2412 is fixed to the bottom of shim space 2410 and is captured by screw 2416. In embodiments, first profile 2412 and second profile 2414 are fixed together by the same screw 2416 to form a unit of attachment for drywall 2422. In use, mullion 2412 of first profile 2402 captures drywall 2422. Screws 2416 are secured at the lower portion of first profile 2402 and covered by removable cap 2418.

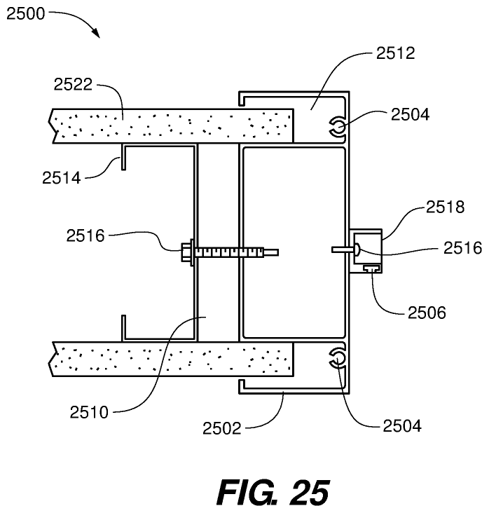

FIG. 25 illustrates connectors 2500, for use with a stud wall at a location of attachment DD7 as illustrated in FIG. 2. In embodiments, connectors 2500 can include first profile 2502, screw spline 2504, rubber gasket 2506, mullion 2512, second profile 2514, screw 2516, and removable cap 2518. In use, second profile 2516 is fixed to a shim space by screw 2516. First profile 2512 is fixed to the bottom of shim space 2510 and is captured by screw 2516. In embodiments, first profile 2512 and second profile 2514 are fixed together by the same screw 2516 to form a unit of attachment for drywall 2522. In use, mullion 2512 of first profile 2502 captures drywall 2522. Screws 2516 are secured at the lower portion of first profile 2502 and covered by removable cap 2518.

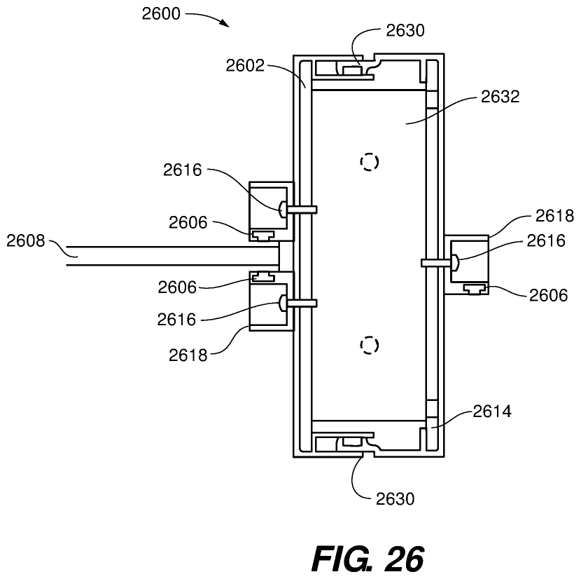

FIG. 26 illustrates connector 2600, for use with a stud wall at a location of attachment DD8 as illustrated in FIGS. 1 and 2. In embodiments, connector 2600 can include first profile 2602, rubber gasket 2606, second profile 2614, screw 2616, removable cap 2618, expansion mullion 2630, and mounting plat 2632. In use, first profile 2602 and second profile 2614 are flexibly couple by expansion mullion 2630. First profile 2602 can optionally be configured to capture glazing and secured by rubber gasket 2606 on either side of glazing 2608. In a non limiting embodiment, expansion mullion 2630 is configured as to allow first profile 2602 and second profile 2614 to expand, slide, or bend. According to embodiments, expansion mullion 2630 creates a flexible junction between two prefabricated wall units such that wall units can be configured to accommodate varying orthogonality or symmetry of an existing space.

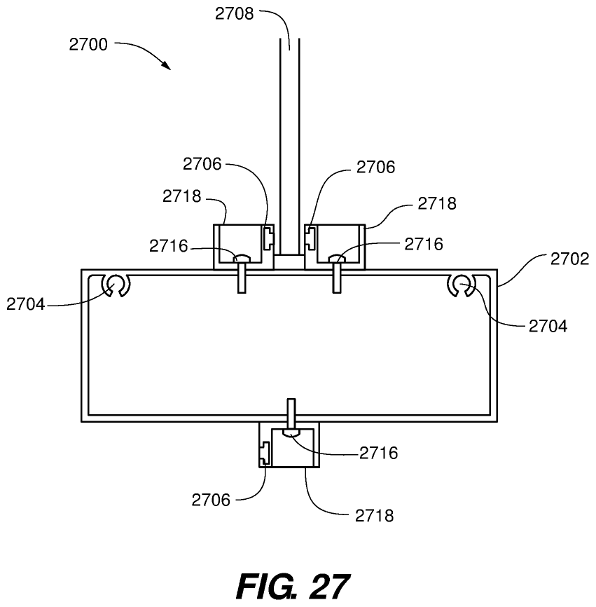

FIG. 27 illustrates connector 2700, for use with a stud wall at a location of attachment DD9 as illustrated in FIG. 1. In embodiments, connector 2700 can include first profile 2702, screw spline 2704, rubber gasket 2706, screw 2716, and removable cap 2718. In use, first profile 2702 is configured to capture glazing 2708. According to an embodiment, a rubber gasket 2706 can be placed on either side of glazing 2708 to secure it to first profile 2702. According to an alternative embodiment, removable caps 2718 can be removed to access screws 2716.

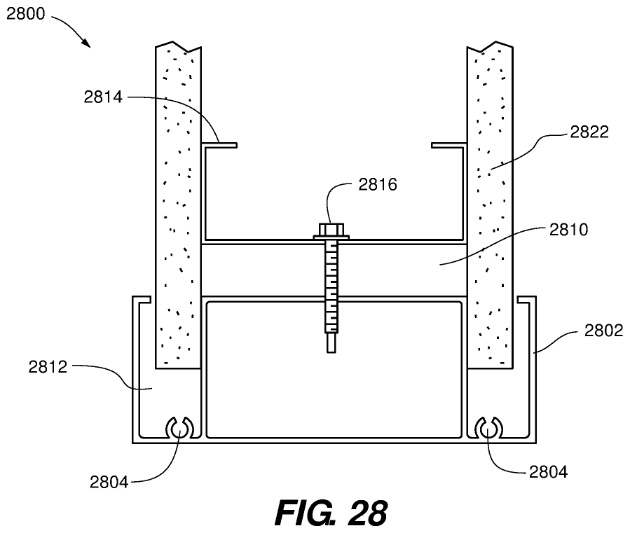

FIG. 28 illustrates connector 2800, for use with a stud wall at a location of attachment DD10 as illustrated in FIG. 1. In embodiments, connector 2800 can include first profile 2802, screw spline 2804, mullion 2812, second profile 2814, and screw 2816. In use, second profile 2816 is fixed to a shim space by screw 2816. First profile 2812 is fixed to the bottom of shim space 2810 and is captured by screw 2816. In embodiments, first profile 2812 and second profile 2814 are fixed together by the same screw 2816 to form a unit of attachment for drywall 2822. In use, mullion 2812 of first profile 2802 captures drywall 2822.

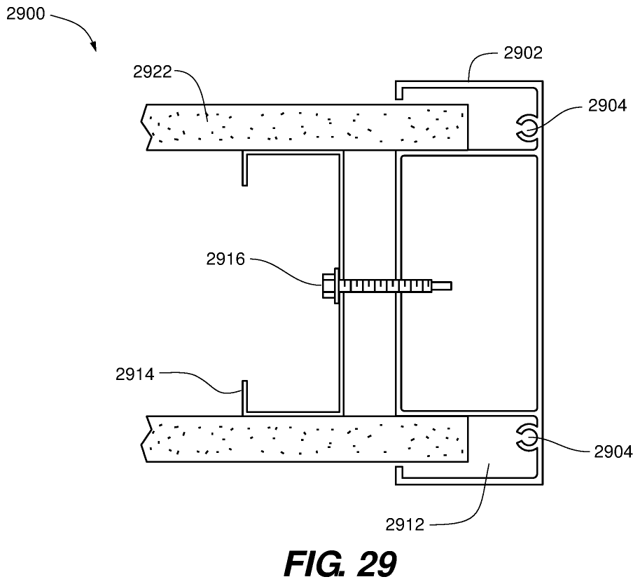

FIG. 29 illustrates connector 2900, for use with a stud wall at a location of attachment DD11 as illustrated in FIG. 3. In embodiments, connector 2900 can include first profile 2902, screw spline 2904, mullion 2912, second profile 2914, and screw 2916. In use, second profile 2916 is fixed to a shim space by screw 2916. First profile 2912 is fixed to the bottom of shim space 2910 and is captured by screw 2916. In embodiments, first profile 2912 and second profile 2914 are fixed together by the same screw 2916 to form a unit of attachment for drywall 2922. In use, mullion 2912 of first profile 2902 captures drywall 2922.

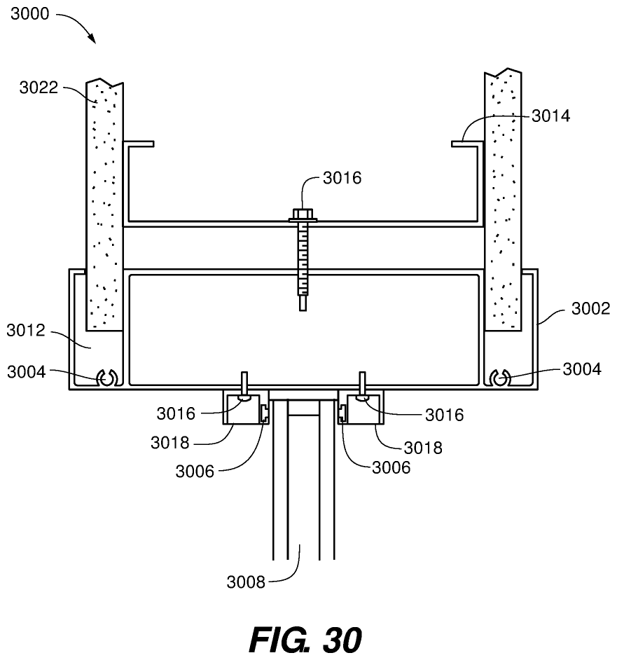

FIG. 30 illustrates connector 3000, for use with a stud wall at a location of attachment DD12 as illustrated in FIGS. 1 and 2. In embodiments, connector 3000 can include first profile 3002, screw spline 3004, rubber gasket 3006, mullion 3012, second profile 3014, screw 3016, and removable cap 3018. In use, second profile 3016 is fixed to a shim space by screw 3016. First profile 3012 is fixed to the bottom of shim space 3010 and is captured by screw 3016. In embodiments, first profile 3012 and second profile 3014 are fixed together by the same screw 3016 to form a unit of attachment for drywall 3022. In use, mullion of first profile 3002 captures drywall 3022. Screws 3016 are secured at the lower portion of first profile 3002 and covered by removable cap 3018.

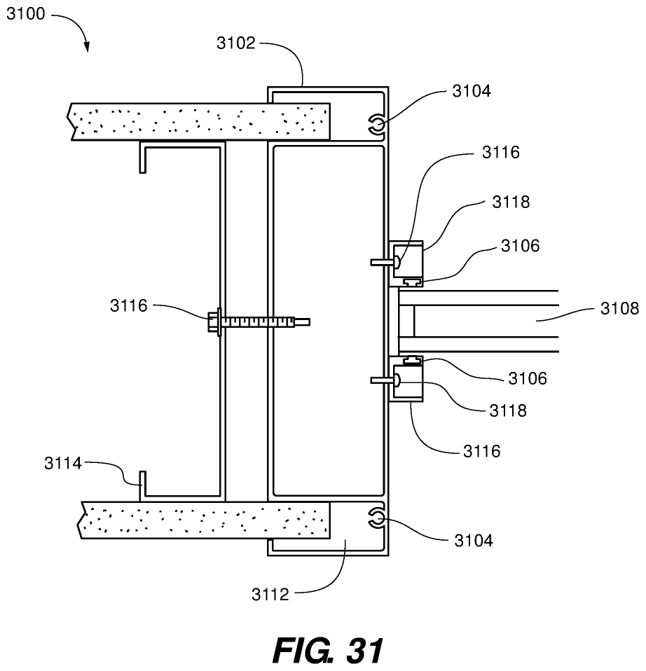

FIG. 31 illustrates connector 3100, for use with a stud wall at a location of attachment DD13 as illustrated in FIG. 4. In embodiments, connector 3100 can include first profile 3102, screw spline 3104, rubber gasket 3106, mullion 3112, second profile 3114, screw 3116, and removable cap 3118. In use, second profile 3116 is fixed to a shim space by screw 3116. First profile 3112 is fixed to the bottom of shim space 3110 and is captured by screw 3116. In embodiments, first profile 3112 and second profile 3114 are fixed together by the same screw 3116 to form a unit of attachment for drywall 3122. In use, mullion of first profile 3102 captures drywall 3122. Screws 3116 are secured at the lower portion of first profile 3102 and covered by removable cap 3118.

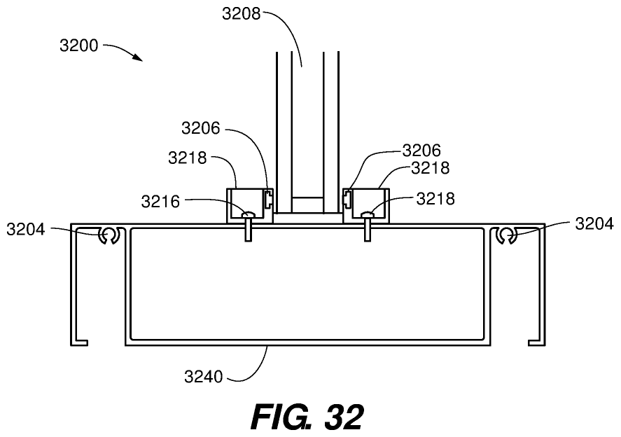

FIG. 32 illustrates connector 3200, for use with a stud wall at a location of attachment DD14 as illustrated in FIG. 4. In embodiments, connector 3200 can include first profile 3202, screw spline 3204, rubber gasket 3206, mullion 3212, screw 3216, and removable cap 3218. In use, screws 3216 are secured to first profile 3240 and covered by removable caps 3218. According to an embodiment, first profile 3240 can be configured to capture glazing 3208. In embodiments, glazing 3208 is secured by rubber gasket 3218.

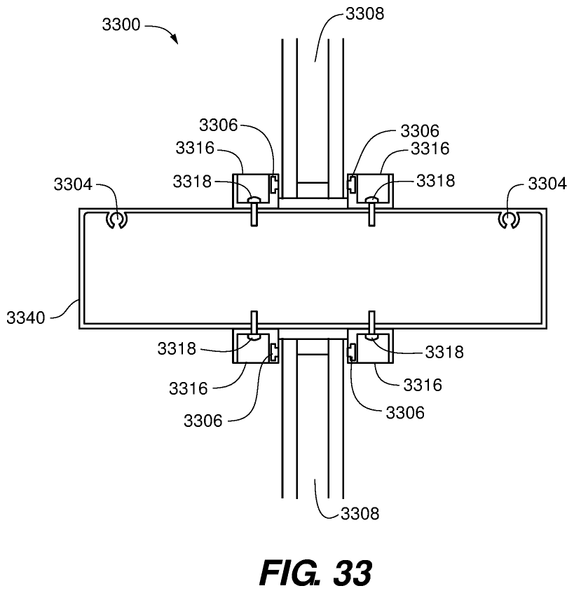

FIG. 33 illustrates connector 3300, for use with a stud wall at a location of attachment DD15 as illustrated in FIG. 4. In embodiments, connector 3300 can include first profile 3340, screw spline 3304, rubber gasket 3306, mullion 3312, screw 3316, and removable cap 3318. In use, screws 3316 are secured to first profile 3340 and covered by removable caps 3318. According to an embodiment, first profile 3340 can be configured to capture glazing 3308 on one or more sides. In embodiments, glazing 3308 is secured by rubber gasket 3318.

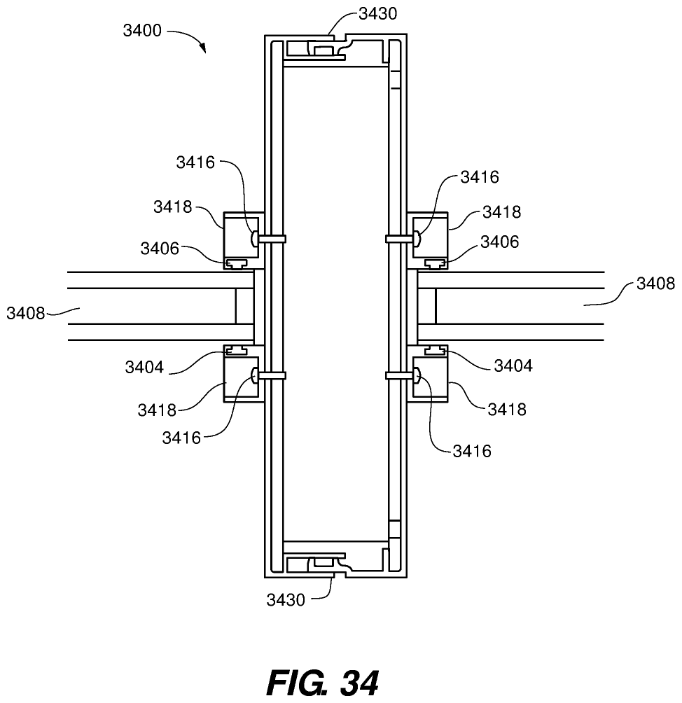

FIG. 34 illustrates connector 3400, for use with a stud wall at a location of attachment DD16 as illustrated in FIG. 1. In embodiments, connector 3400 can include first profile 3402, rubber gasket 3406, second profile 3414, screw 3416, removable cap 3418, expansion mullion 3430, and mounting plat 3432. In use, first profile 3402 and second profile 3414 are flexibly couple by expansion mullion 3430. First profile 3402 can optionally be configured to capture glazing and secured by rubber gasket 3406 on either side of glazing 3408. In a non limiting embodiment, expansion mullion 3430 is configured as to allow first profile 3402 and second profile 3414 to expand, slide, or bend. According to embodiments, expansion mullion 3430 creates a flexible junction between two prefabricated wall units such that wall units can be configured to accommodate varying orthogonality or symmetry of an existing space.

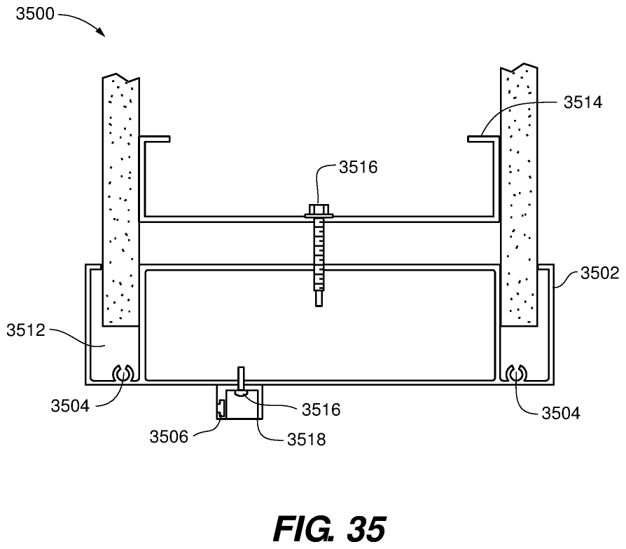

FIG. 35 illustrates connector 3500, for use with a stud wall at a location of attachment DD17 as illustrated in FIG. 2. In embodiments, connector 3500 can include first profile 3502, screw spline 3504, rubber gasket 3506, mullion 3512, second profile 3514, screw 3516, and removable cap 3518. In use, second profile 3516 is fixed to a shim space by screw 3516. First profile 3512 is fixed to the bottom of shim space 3510 and is captured by screw 3516. In embodiments, first profile 3512 and second profile 3514 are fixed together by the same screw 3516 to form a unit of attachment for drywall 3522. In use, mullion of first profile 3502 captures drywall 3522. Screws 3516 are secured at the lower portion of first profile 3502 and covered by removable cap 3518.

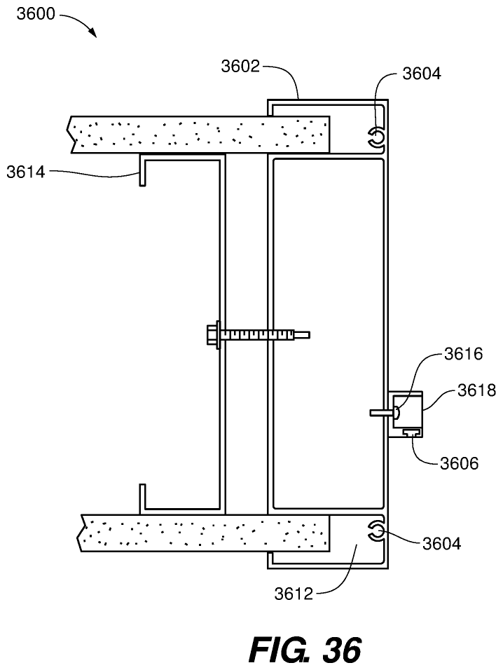

FIG. 36 illustrates connector 3600, for use with a stud wall at a location of attachment DD18 as illustrated in FIGS. 1 and 2. In embodiments, connector 3600 can include first profile 3602, screw spline 3604, rubber gasket 3606, mullion 3612, second profile 3614, screw 3616, and removable cap 3618. In use, second profile 3616 is fixed to a shim space by screw 3616. First profile 3612 is fixed to the bottom of shim space 3610 and is captured by screw 3616. In embodiments, first profile 3612 and second profile 3614 are fixed together by the same screw 3616 to form a unit of attachment for drywall 3622. In use, mullion of first profile 3602 captures drywall 3622. Screws 3616 are secured at the lower portion of first profile 3602 and covered by removable cap 3618.

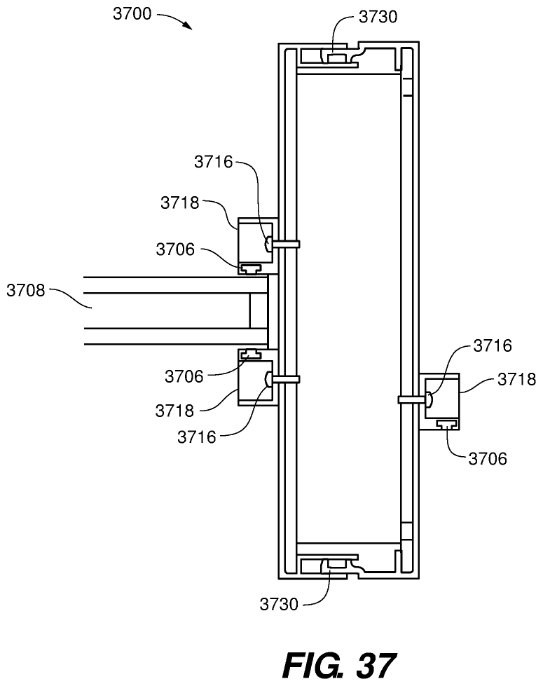

FIG. 37 illustrates connector 3700, for use with a stud wall at a location of attachment DD19 as illustrated in FIGS. 1 and 2. In embodiments, connector 3700 can include first profile 3702, rubber gasket 3706, second profile 3714, screw 3716, removable cap 3718, expansion mullion 3730, and mounting plat 3732. In use, first profile 3702 and second profile 3714 are flexibly couple by expansion mullion 3730. First profile 3702 can optionally be configured to capture glazing and secured by rubber gasket 3706 on either side of glazing 3708. In a non limiting embodiment, expansion mullion 3730 is configured as to allow first profile 3702 and second profile 3714 to expand, slide, or bend. According to embodiments, expansion mullion 3730 creates a flexible junction between two prefabricated wall units such that wall units can be configured to accommodate varying orthogonality or symmetry of an existing space.

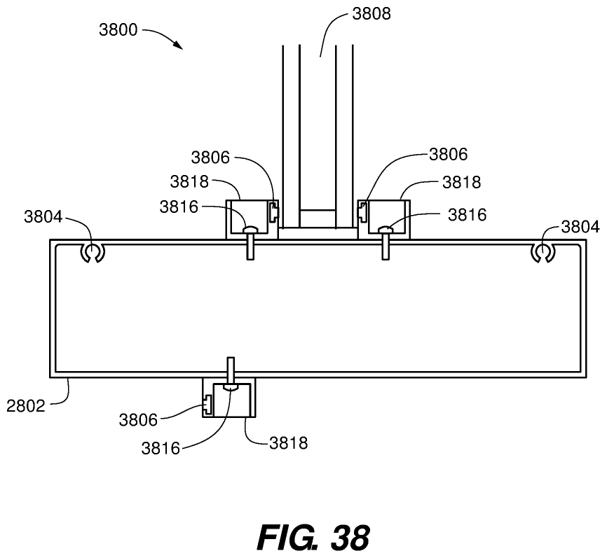

FIG. 38 illustrates connector 3800, for use with a stud wall at a location of attachment DD20 as illustrated in FIG. 1. In embodiments, connector 3800 can include first profile 3802, rubber gasket 3806, second profile 3814, screw 3816, removable cap 3818, expansion mullion 3830, and mounting plat 3832. In use, first profile 3802 and second profile 3814 are flexibly couple by expansion mullion 3830. First profile 3802 can optionally be configured to capture glazing and secured by rubber gasket 3806 on either side of glazing 3808. In a non limiting embodiment, expansion mullion 3830 is configured as to allow first profile 3802 and second profile 3814 to expand, slide, or bend. According to embodiments, expansion mullion 3830 creates a flexible junction between two prefabricated wall units such that wall units can be configured to accommodate varying orthogonality or symmetry of an existing space.

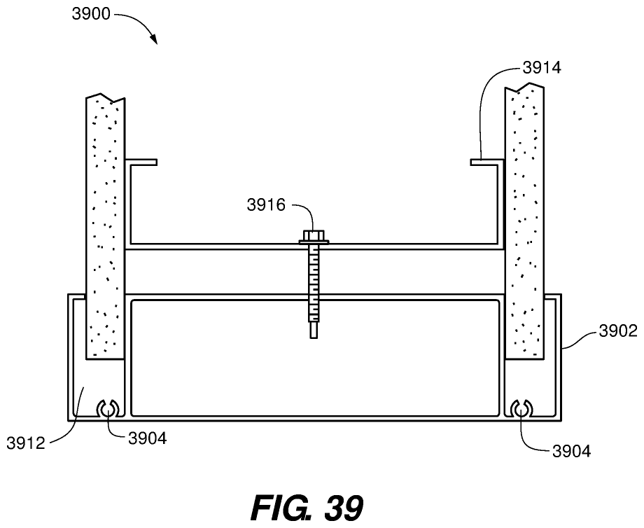

FIG. 39 illustrates connector 3900, for use with a stud wall at a location of attachment DD21 as illustrated in FIG. 3. In embodiments, connector 3900 can include first profile 3902, screw spline 3904, mullion 3912, second profile 3914, and screw 3916. In use, second profile 3916 is fixed to a shim space by screw 3916. First profile 3912 is fixed to the bottom of shim space 3910 and is captured by screw 3916. In embodiments, first profile 3912 and second profile 3914 are fixed together by the same screw 3916 to form a unit of attachment for drywall 3922. In use, mullion 3912 of first profile 3902 captures drywall 3922.

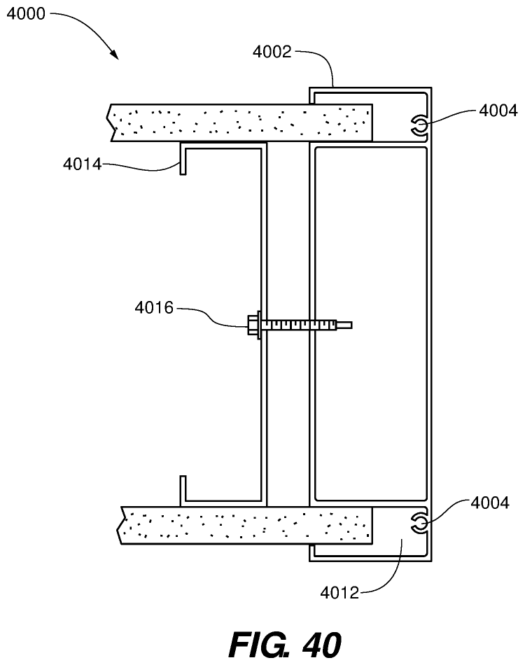

FIG. 40 illustrates connector 4000, for use with a stud wall at a location of attachment DD21 as illustrated in FIG. 3. In embodiments, connector 4000 can include first profile 4002, screw spline 4004, mullion 4012, second profile 4014, and screw 4016. In use, second profile 4016 is fixed to a shim space by screw 4016. First profile is fixed to the bottom of shim space 4010 and is captured by screw 4016. In embodiments, first profile 4012 and second profile 4014 are fixed together by the same screw 4016 to form a unit of attachment for drywall 4022. In use, mullion 4012 of first profile 4002 captures drywall 4022.

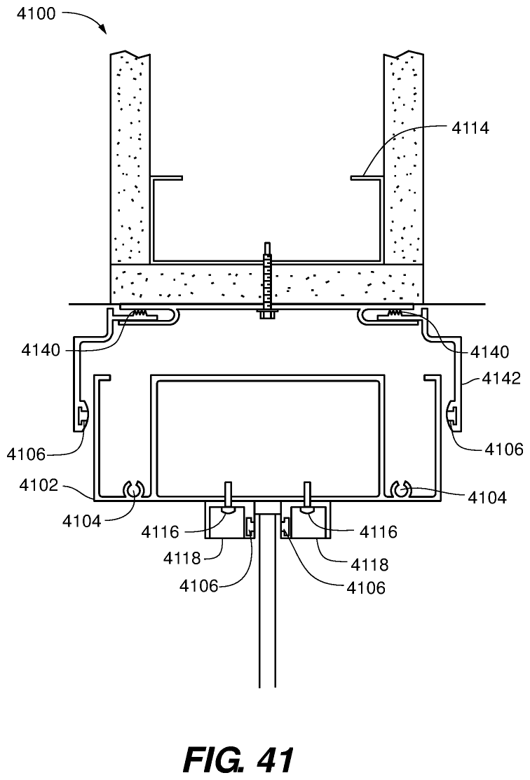

FIG. 41 illustrates connector 4100, for use with pre-existing walls or structures at a location of attachment DD23 as illustrated in FIGS. 5 and 6. In embodiments, connector 4100 can include first profile 4102, screw spline 4104, rubber gasket 4106, second profile 4114, screw 4116, removable cover 4118, third profile 4142, and serrated joint 4140. In use, third profile 4142 is fixed to drywall or a preexisting structure (not labeled) by screw 4116 and second profile is fixed to the opposite side of the drywall or preexisting structure and is captured by screw 4116. In embodiments, second profile 4102 is coupled to third profile 4142 by serrated joint 4140. Screws 4116 are secured at the lower portion of first profile 4102 and covered by removable cap 4118. Glazing is fixed to first profile 4102 and rubber gaskets 4106 are placed on either side of glazing 4108 to secure it in place.

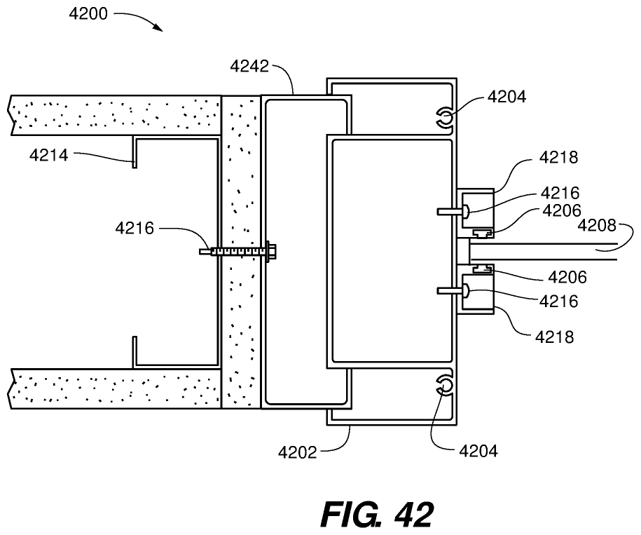

FIG. 42 illustrates connector 4200, for use with pre-existing walls or structures at a location of attachment DD24 as illustrated in FIGS. 5 and 6. In embodiments, connector 4200 can include first profile 4202, screw spline 4204, rubber gasket 4206, second profile 4214, screw 4216, removable cover 4218, and third profile 4242. In use, third profile 4242 is fixed to drywall or a preexisting structure (not labeled) by screw 4216 and second profile is fixed to the opposite side of the drywall or preexisting structure and is captured by screw 4216. In one embodiment, second profile 4202 is coupled to third profile 4242 with screws. Screws 4216 are secured at the lower portion of first profile 4202 and covered by removable cap 4218. Glazing is fixed to first profile 4202 and rubber gaskets 4206 are placed on either side of glazing 4208 to secure it in place.

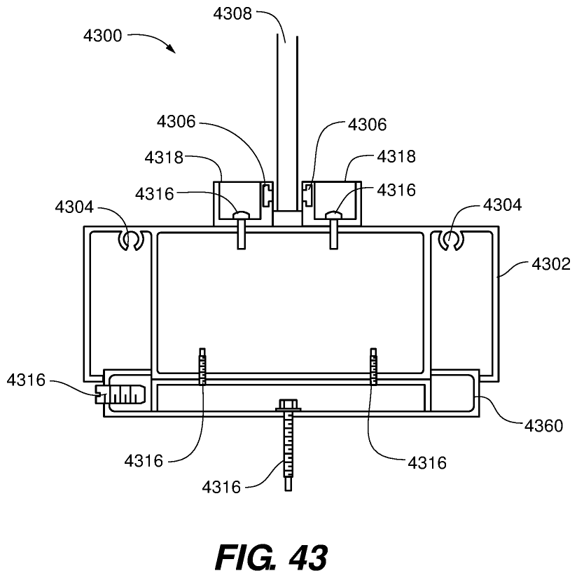

FIG. 43 illustrates connector 4300, for use with pre-existing walls or structures at a location of attachment DD25 as illustrated in FIGS. 5 and 6. In embodiments, connectors 4300 can include first profile 4302, screw spline 4304, rubber gasket 4306, screw 4316, removable cap 4318, and base profile 4360. In use, base profile is fixed to a surface by a screw 4316. First profile 4302 is coupled to the base profile 4360 is such a way that it is configured to capture glazing 4308. Glazing is fixed to first profile 4302 and rubber gaskets 4306 are placed on either side of glazing 4308 to secure it in place.

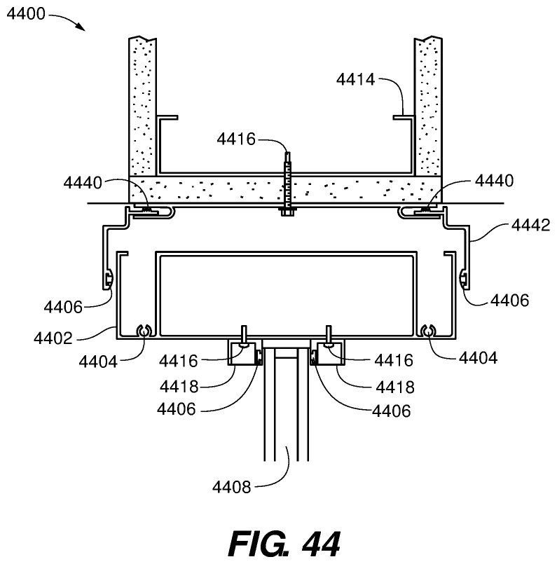

FIG. 44 illustrates connector 4400, for use with pre-existing walls or structures at a location of attachment DD26 as illustrated in FIGS. 5 and 6. In embodiments, connector 4400 can include first profile 4402, screw spline 44104, rubber gasket 4406, second profile 4414, screw 4416, removable cover 4418, third profile 4442, and serrated joint 4440. In use, third profile 4442 is fixed to drywall or a preexisting structure (not labeled) by screw 4416 and second profile is fixed to the opposite side of the drywall or preexisting structure and is captured by screw 4416. In embodiments, second profile 4402 is coupled to third profile 4442 by serrated joint 4440. Screws 4416 are secured at the lower portion of first profile 4402 and covered by removable cap 4418. Glazing is fixed to first profile 4402 and rubber gaskets 4406 are placed on either side of glazing 4408 to secure it in place.

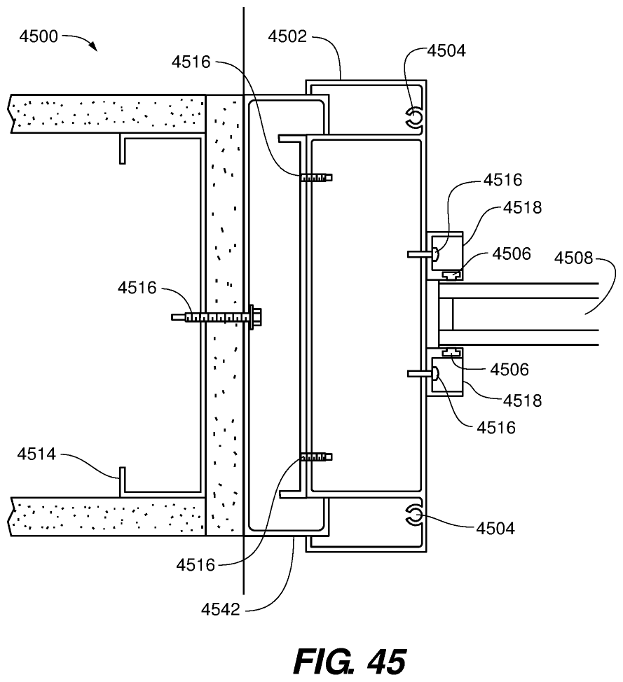

FIG. 45 illustrates connector 4500, for use with pre-existing walls or structures at a location of attachment DD27 as illustrated in FIGS. 5 and 6. In embodiments, connector 4500 can include first profile 4502, screw spline 4504, rubber gasket 4506, second profile 4514, screw 4516, removable cover 4518, and third profile 4542. In use, third profile 4542 is fixed to drywall or a preexisting structure (not labeled) by screw 4516 and second profile is fixed to the opposite side of the drywall or preexisting structure and is captured by screw 4516. In one embodiment, second profile 4502 is coupled to third profile 4542 with screws. Screws 4516 are secured at the lower portion of first profile 4502 and covered by removable cap 4518. Glazing is fixed to first profile 4502 and rubber gaskets 4506 are placed on either side of glazing 4508 to secure it in place.

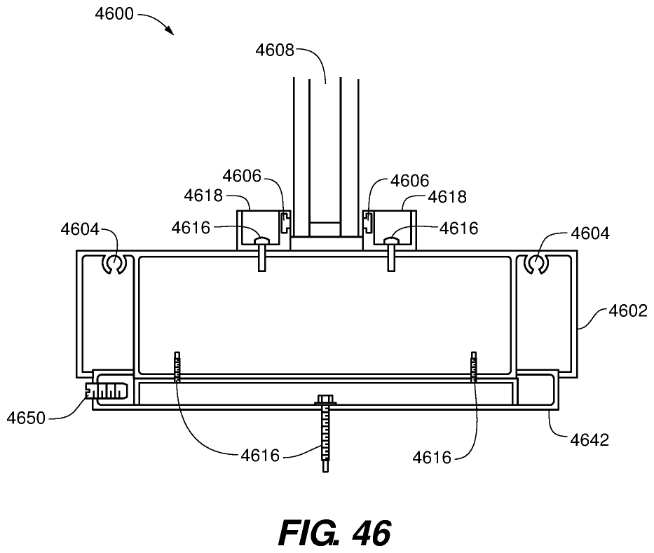

FIG. 46 illustrates connector 4600, for use with pre-existing walls or structures at a location of attachment DD27 as illustrated in FIGS. 5 and 6. In embodiments, connectors 4600 can include first profile 4602, screw spline 4604, rubber gasket 4606, screw 4616, removable cap 4618, and base profile 4660. In use, base profile is fixed to a surface by a screw 4616. First profile 4602 is coupled to the base profile 4660 is such a way that it is configured to capture glazing 4608. Glazing is fixed to first profile 4602 and rubber gaskets 4606 are placed on either side of glazing 4608 to secure it in place.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A modular, lightweight, non-load bearing, space-dividing architectural wall system configured to be installed in an opening defined by one or more studs of an interior wall and to interlock with one or more at least partially surrounding panels of sheet rock adhered to the one or more studs, the architectural wall system comprising:
one or more modular panels, each modular panel including at least a three sided extruded metal perimeter frame having a cross-section including
a rectangular tubular portion configured to be secured to one or more studs of an interior wall, the rectangular tubular portion having a width sized to match the width of the one or more studs; and
a pair of opposed sheet rock accommodating brackets extending beyond the width of the rectangular tubular portion, the pair of opposed sheet rock accommodating brackets each defining a channel configured to receive an edge of the one or more at least partially surrounding panels of sheet rock, thereby interlocking the perimeter frame with the at least partially surrounding panels of sheet rock to further secure the perimeter frame to the interior wall and to provide a finished appearance to the opening.

2. The architectural wall system of claim 1, wherein the opposed sheet rock accommodating brackets are configured to receive a panel of sheet rock having a standard thickness approximating of one of ½ of an inch and/or ⅜ of an inch.

3. The architectural wall system of claim 1, wherein the width of the rectangular tubular portion is approximating one of 1⅜ inches, 1⅝ inches, 2 inches, 2½ inches, and/or 3 inches.

4. The architectural wall system of claim 1, wherein a depth of the pair of opposed sheet rock accommodating brackets is the same as a depth of the rectangular tubular portion, thereby enabling two or more modular panels to be secured together with a finished appearance.

5. The architectural wall system of claim 1, further comprising one or more of shims configured to be positioned between the perimeter frame and the one or more studs prior to securing the rectangular tubular portion to the one or more studs of the interior wall.

6. The architectural wall system of claim 1, wherein the perimeter frame houses a rigid panel.

7. The architectural wall system of claim 6, wherein the rigid panel includes at least one of a transparent and/or translucent portion.

8. The architectural wall system of claim 6, wherein the rigid panel includes at least one of a hinged and/or a sliding window.

9. The architectural wall system of claim 6, wherein the rigid panel includes at least one of an electrical outlet and/or other electrical coupling.

10. The architectural wall system of claim 1, wherein the perimeter frame houses a pivotable door.

11. A method of constructing a modular, lightweight, non-load bearing, space-dividing architectural wall system in an opening defined by one or more studs of an interior wall, the method comprising:
partially building an interior wall with one or more studs, wherein the one or more studs define an opening;
securing one or more modular panels within the opening defined by the one or more studs, each modular panel including at least a three sided extruded metal perimeter frame having a cross-section including
a rectangular tubular portion configured to be secured to the one or more studs and having a width sized to match the width of the one or more studs; and
a pair of opposed sheet rock accommodating brackets extending beyond the width of the rectangular tubular portion, the pair of opposed sheet rock accommodating brackets each defining a channel; and
adhering one or more panels of sheet rock to the one or more studs of the interior wall, such that the one or more modular panels are at least partially surrounded by the one or more panels of sheet rock, wherein an edge of at least one of the one or more at least partially surrounding panels of sheet rock is received within the channel defined by the sheet rock accommodating brackets, thereby interlocking the perimeter frame with the at least partially surrounding panels of sheet rock to further secure the perimeter frame to the interior wall and to provide a finished appearance to the opening.

12. The method of claim 11, wherein the opposed sheet rock accommodating brackets are configured to receive a panel of sheet rock having a standard thickness approximating of one of ½ of an inch and/or ⅜ of an inch.

13. The method of claim 11, wherein the width of the rectangular tubular portion is approximating one of 1⅜ inches, 1⅝ inches, 2 inches, 2½ inches, and/or 3 inches.

14. The method of claim 11, wherein a depth of the pair of opposed sheet rock accommodating brackets is the same as a depth of the rectangular tubular portion, thereby enabling two or more modular panels to be secured together with a finished appearance.

15. The method of claim 11, further comprising positioning one or more of shims between the perimeter frame and the one or more studs prior to securing the rectangular tubular portion to the one or more studs of the interior wall.

16. The method of claim 11, wherein the perimeter frame houses a rigid panel.

17. The method of claim 16, wherein the rigid panel includes at least one of a transparent and/or translucent portion.

18. The method of claim 16, wherein the rigid panel includes at least one of a hinged and/or a sliding window.

19. The method of claim 16, wherein the rigid panel includes at least one of an electrical outlet and/or other electrical coupling.

20. The method of claim 11, wherein the perimeter frame houses a pivotable door.
